(19) United States
(12) Patent Application Publication
(10) Pub. No.: US 2011/0036783 A1
(43) Pub. Date: Feb. 17, 2011

(54) SYSTEM FOR REDUCING OVERFLOW DISCHARGES FROM COMBINED SEWER SYSTEM

(76) Inventor: Bart Chezar, Brooklyn, NY (US)

Correspondence Address: SCHNADER HARRISON SEGAL & LEWIS, LLP, 1600 MARKET STREET, SUITE 3600, PHILADELPHIA, PA, 19103, US

(21) Appl. No.: 12/540,926

(22) Filed: Aug. 13, 2009

(51) Int. Cl. B01D 35/157

(52) U.S. Cl. 210/744; 210/86

(57) ABSTRACT

A system for controlling discharges of untreated water from a Combined Sewer System carrying rainwater and sewage from a drainage basin and having a Combined Sewage Overflow for discharging untreated material comprises the following: at least one cistern located within the drainage basin served by the Combined Sewer System, the cistern being positioned to capture rainwater that is collected from a portion of the drainage basin, the cistern having a drainage outlet for discharging water into the Combined Sewer System, the drainage outlet having a control valve positioned to control water flow through the drainage outlet, and the cistern also having an overflow outlet configured to discharge rainwater in the event that the cistern contains an amount of water approaching its capacity; a detector for obtaining data that correlates with water being discharged through the Combined Sewage Overflow; and a transmitter for remotely controlling the control valve. The system is operated such that when a discharge is not occurring at the Combined Sewer Overflow, the control valve remains open and rainwater flows through the system into the Combined Sewer System. When a discharge is occurring through the Combined Sewer Overflow, the control valve is closed and rainwater is stored within the cistern.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF PARTIES TO JOINT RESEARCH AGREEMENT

Not applicable.

### REFERENCE TO A “SEQUENCE LISTING,” A TABLE, OR A COMPUTER PROGRAM LISTING APPENDIX

Not applicable.

### FIELD OF THE INVENTION

This invention relates to the field of Combined Sewer Systems. Throughout this application, the term “water” will refer to matter flowing through any of the systems described herein. The flowing matter includes water and a variety of other liquid and solid materials.

### BACKGROUND OF THE INVENTION

In a Combined Sewer System, rainwater and sewage are combined into a single flow. The water from the Combined Sewer System ordinarily passes through a sewage-treatment plant before the treated water is discharged into a body of water. However, rain often falls at a rate such that the combined flow of sewage and rainwater exceeds the capacity of the sewage-treatment plant or the capacity of the sewer lines leading to the sewage-treatment plant. When such a rain occurs, a combination of rainwater and sewage is discharged without undergoing full treatment. The discharge occurs through a Combined Sewer Overflow (“CSO”). Operators of Combined Sewer Systems want to decrease the frequency and the volume of untreated discharges occurring through CSOs.

### SUMMARY OF THE INVENTION

The inventor has conceived a system that reduces discharges through a CSO by controlling the flow of rainwater from individual buildings (or other sources of rainwater) into the Combined Sewer System. The system accomplishes this goal by capturing rainwater that otherwise would be combined with sewage and cause a discharge from the CSO and holding it until discharging it will not cause the combined water flow in the Combined Sewer System to exceed the capacity of the sewage-treatment plant or the capacity of the sewer lines leading to the plant.

### DESCRIPTION OF THE DRAWINGS

The invention is best understood from the following detailed description when read with the accompanying drawings.

FIG. 1 shows a system according to an illustrative embodiment of the invention. The broken line indicates where the invention intercepts and replaces part of the building's downspout.

FIG. 2 shows a system according to an illustrative embodiment of the invention. Rainwater is flowing into the cistern, and the control valve is open with water flowing into the sewer line.

FIG. 3 shows a system according to an illustrative embodiment of the invention. Rainwater is flowing into the cistern, and the control valve has closed responding to receiving a signal from the transmitter.

FIG. 4 shows a system according to an illustrative embodiment of the invention. Rainwater is flowing into the cistern, the control valve is closed, and water is accumulating in the cistern.

FIG. 5 shows a system according to an illustrative embodiment of the invention. Rainwater is flowing into the cistern, the control valve is closed, water has filled the cistern to its capacity, and the overflow outlet is discharging rainwater.

FIG. 6 shows a system according to an illustrative embodiment of the invention. Rainwater has stopped flowing into the cistern, the control valve is closed, water has filled the cistern to its capacity, and the overflow outlet has stopped discharging rainwater.

FIG. 7 shows a system according to an illustrative embodiment of the invention. Rainwater has stopped flowing into the cistern, the control valve is open due to cessation of the signal from the transmitter, and the water held in the cistern is being discharged through the drainage outlet into the sewer line.

### DETAILED DESCRIPTION OF THE INVENTION

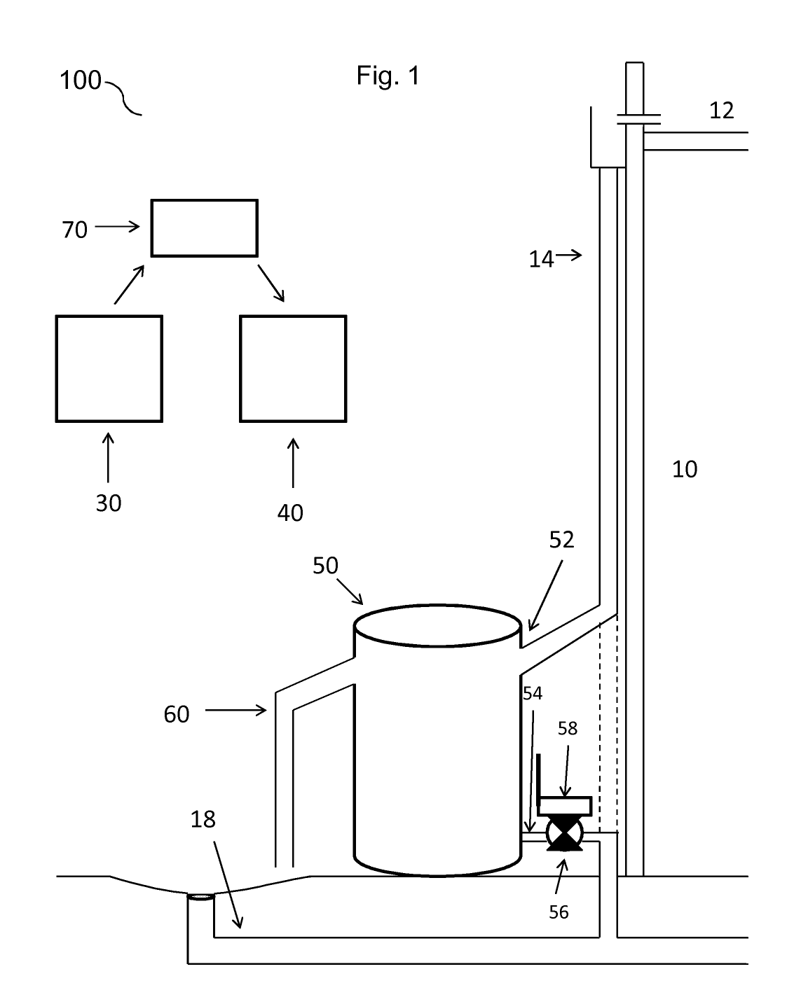

Described herein is an exemplary embodiment of a system 100 according to the invention for controlling discharges of untreated water from a Combined Sewer System. The Combined Sewer System carries rainwater and sewage from a drainage basin and has a Combined Sewer Overflow (“CSO”) for discharging untreated material. As shown in FIG. 1, the exemplary system according to the invention includes at least one cistern 50 located within the drainage basin served by the Combined Sewer System, the cistern 50 being positioned to capture rainwater that is collected from a portion of the drainage basin. A cistern 50 may take the form of a vessel of metal, masonry, plastic, or any other suitable material. The size of the cistern is not subject to any specific constraints, but the size of the cistern provides an upper limit on the volume of excess rainwater that the cistern may hold. In the exemplary embodiment, the cistern 50 captures rainwater from roof 12 of building 10. Rainwater flows from roof 12 through downspout 14 through inlet 52 to cistern 50. Cistern 50 has drainage outlet 54 for discharging water into the Combined Sewer System via sewer line 18. Drainage outlet 54 has control valve 56 positioned to control water flow to the sewer line 18. Cistern 50 also has overflow outlet 60 configured to discharge rainwater into sewer line 18 in the event that the cistern 50 contains an amount of water exceeding capacity.

In the exemplary embodiment, system 100 further comprises detector 30, which receives data that is either a direct measure of, or correlate to, a discharge from the CSO. In various embodiments, detector 30 may receive the data in any of numerous ways, including measurement by the detector itself of fluid levels or flows within the combined sewer distribution system, at the sewage treatment plant, using rain gauges to measure the volume and/or intensity of a rain “event,” or receiving rain data gathered by others. System 100 further comprises transmitter 40 for remotely controlling the control valve. In the exemplary embodiment, transmitter 40 may take the form of a radio transmitter in communication with receiver 58 in communication to receive a signal to open or close the control valve 56. Transmitter 40 may take the form of any other type of remote communication device, including but not limited to devices sending signals over telephone wires, internet-based systems, or cellular telephone systems. In certain embodiments, system 100 further comprises controller 70 in operative communication with detector 30 and transmitter 40 so that controller 30 may receive data from detector 30, process the data, and then cause transmitter 40 to make an appropriate transmission to open or close the control valve 56. Alternatively, in certain embodiments controller 70 may be omitted, and detector 30 may communicate directly with transmitter 40. Processing the data might include determining that control valve 56 should be closed when rainfall exceeds a certain threshold in a certain length of time. In the embodiment shown, controller 70 may be a general-purpose computer programmed to receive data from detector 30, process it, and cause transmitter 40 to issue appropriate transmissions. Optionally, system 100 includes a plurality of receivers 58 connected to a plurality of control valves 56, which may be located at a plurality of buildings or locations. In that embodiment, each receiver 58 may be controlled individually, or the plurality of receivers 58 may be broken into two or more groups that are controlled by a common transmission. In this way, the controller 70 may stagger releases of rainwater from the plurality of cisterns in order to control the flow caused by such releases and prevent a discharge from the CSO when control valves 56 are opened following a closure thereof. In certain embodiments, system 100 includes a solenoid in operative communication with the receiver 58 and the control valve 56 such that the control valve 56 is opened and closed in response to a signal from the transmitter 40. This may be accomplished by using a solenoid-controlled valve for the control valve 56 and a receiver 58 capable of generating an electrical signal or current to control the solenoid controlled valve. In certain embodiments, the control valve 56 is configured so that when no signal is received from the transmitter 30, the control valve 56 permits rainwater to flow out of the cistern 50 and the control valve is closed only when a signal is received by receiver 58. This may be accomplished by using a solenoid controlled valve that is open in the absence of a signal at the control valve 56.

In certain embodiments, discharge outlet 54 is located in the lower portion of the cistern 50, and the overflow outlet 60 is located in the upper portion of the cistern 50. This configuration takes advantage of gravitational flow to allow flow through the overflow outlet 60. However, it is possible to locate the overflow outlet 60 elsewhere within the cistern by adding an overflow outlet control valve to the system to control the flow of water in overflow outlet 60.

The drawing figures show an exemplary embodiment of the invention in several different states of operation. In FIG. 1, the system 100 is not receiving, discharging or holding water. No water flow is occurring.

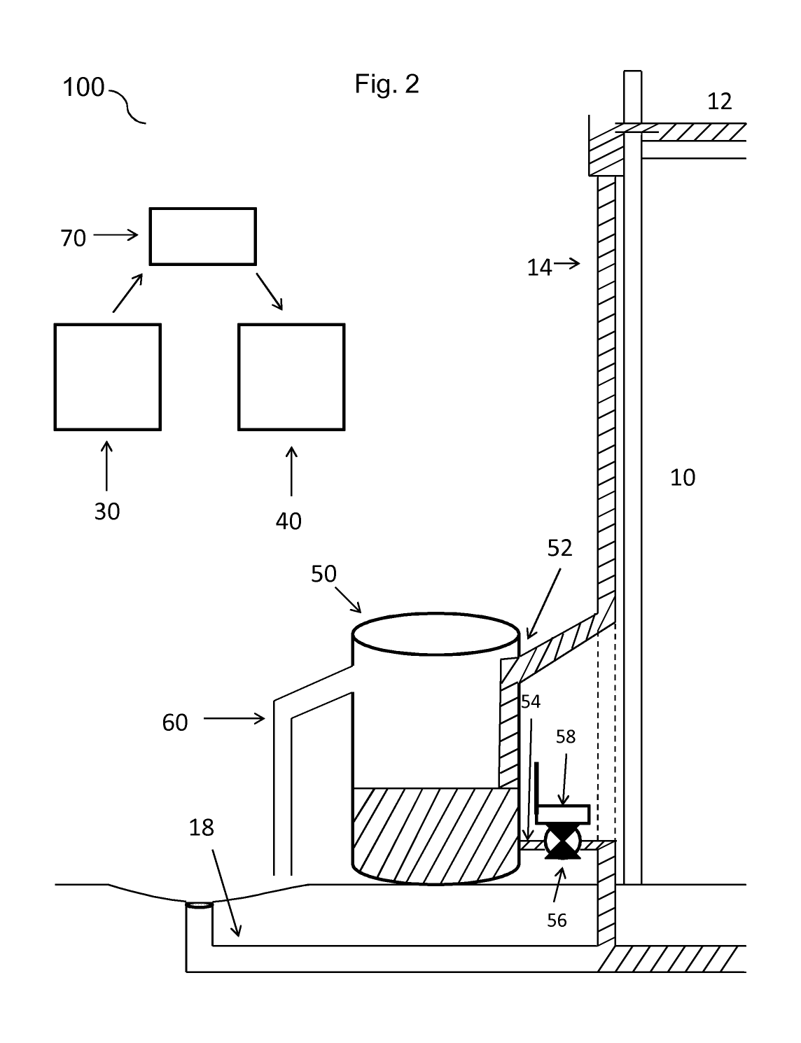

In FIG. 2, rain is falling in the drainage basin (including rooftop 12), rainwater is flowing into the cistern 50 through inlet 52, and the control valve 56 is open, permitting the rainwater to flow into sewer line 18.

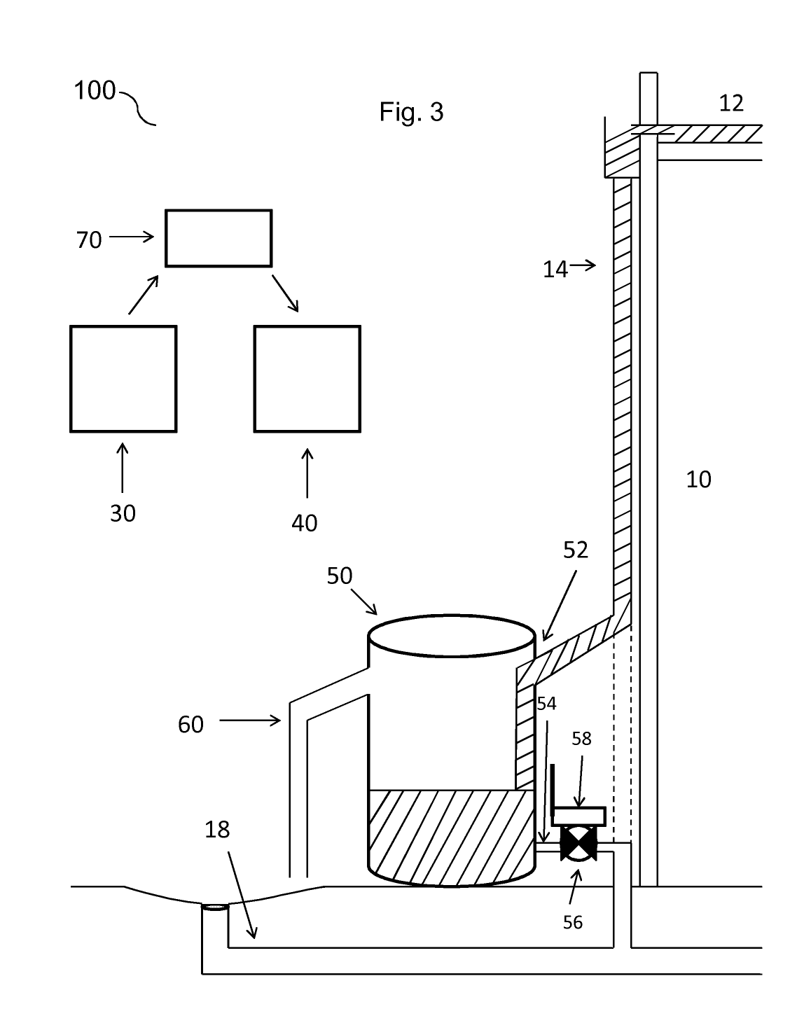

In FIG. 3, the detector 30 has detected a condition that correlates with a discharge from the CSO. Information from the detector has been processed by the controller 70, which has caused the transmitter 40 to transmit a signal to close control valve 56. Transmitter 40 has sent a signal, which was received by receiver 58, to close control valve 56. Rainwater is flowing into the cistern 50, and the control valve 56 has been closed.

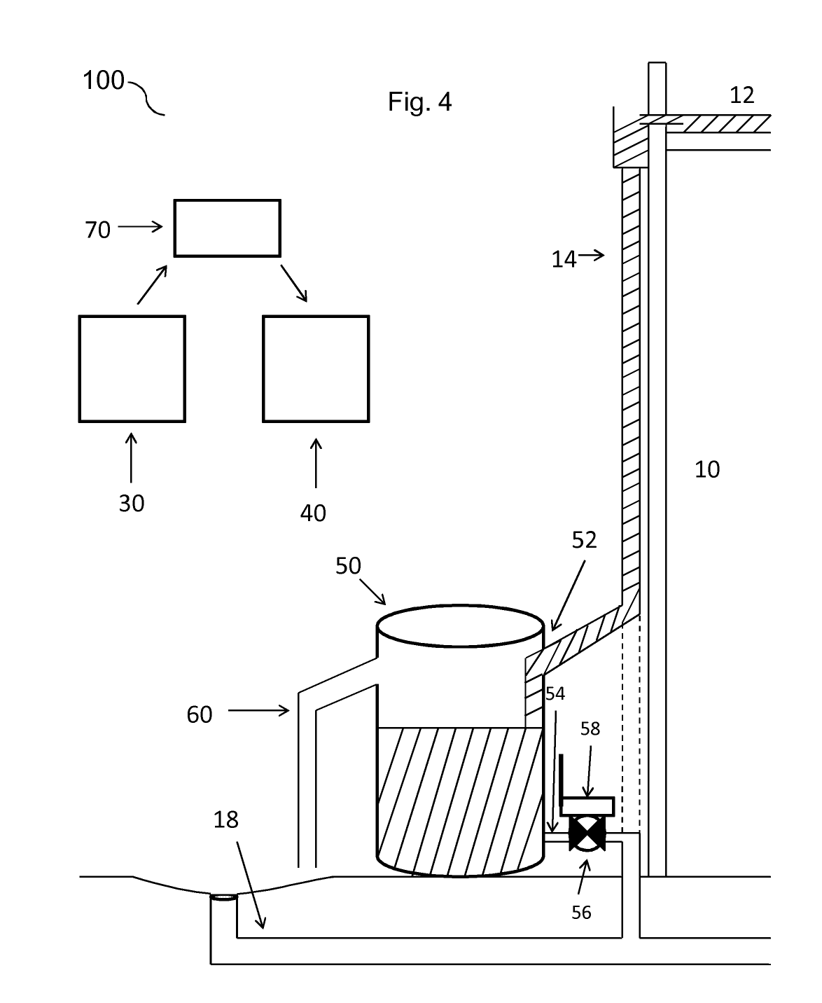

In FIG. 4 rainwater is flowing into the cistern 50, the control valve 56 is closed, and water is accumulating in the cistern 50. The volume of accumulating rainwater causes a corresponding reduction in the volume of liquid in the Combined Sewer System, thus reducing discharges through the CSO.

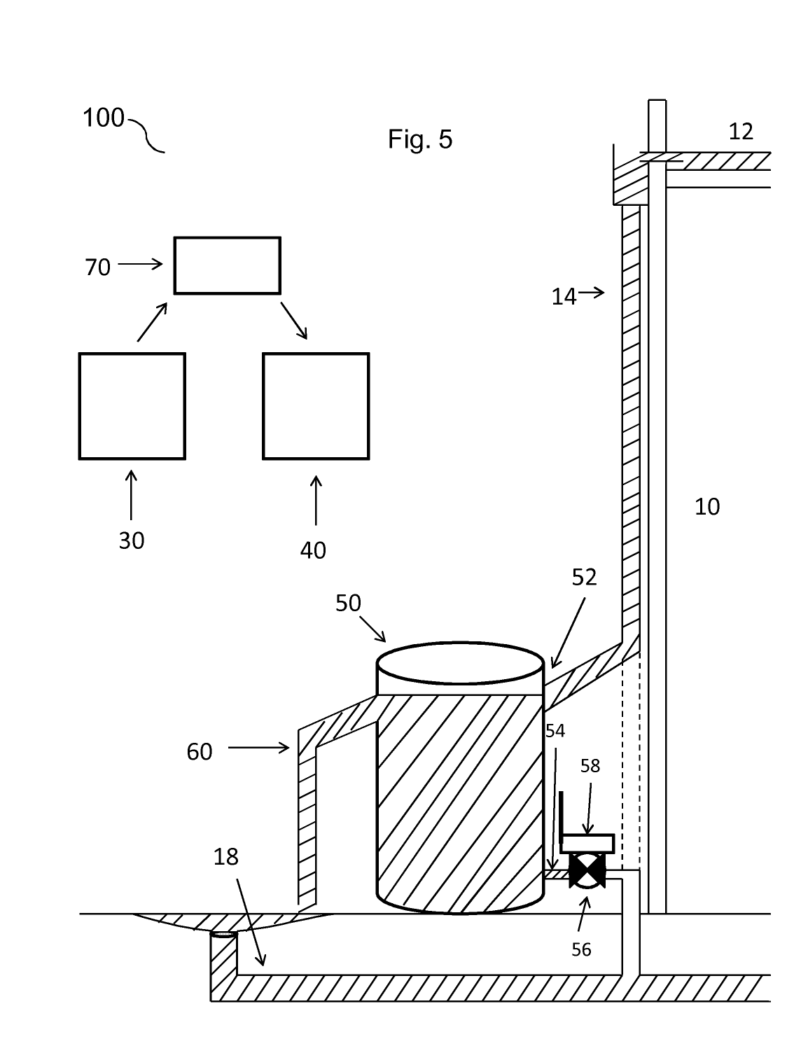

In FIG. 5, rainwater is flowing into the cistern 50 and has filled it to its capacity. The control valve 56 is closed, and the overflow outlet 60 is discharging rainwater into the Combined Sewer System. But even if the rainwater flowing from the overflow outlet 60 causes a discharge through the CSO, the volume of the discharge through the CSO has been reduced due to the storage of rainwater in the cistern 50.

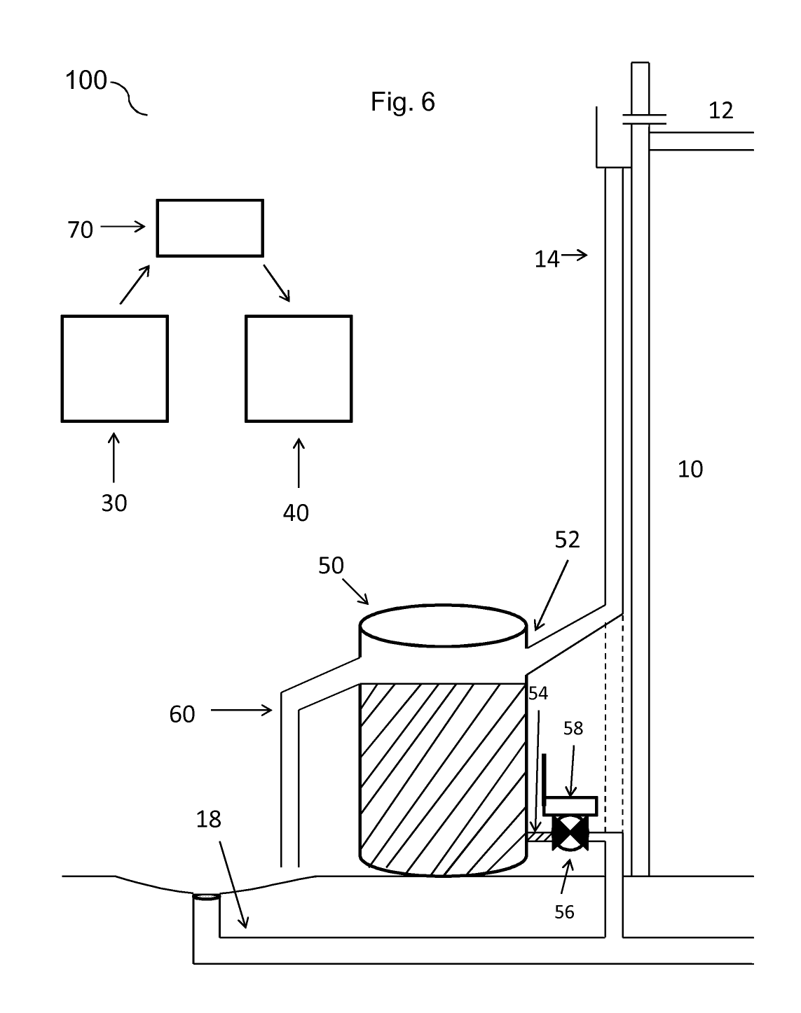

In FIG. 6, rainwater has stopped flowing into the cistern 50, the control valve 56 is closed, the cistern 50 is filled to its capacity, and the overflow outlet 60 has stopped discharging rainwater.

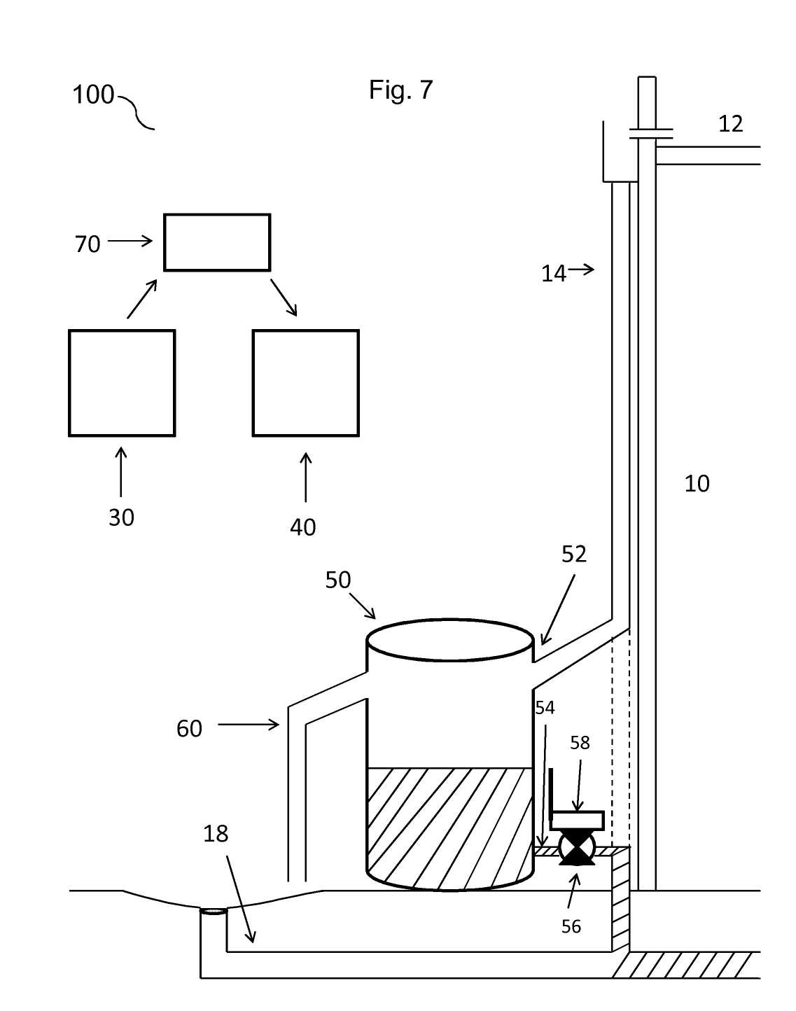

In FIG. 7, rainwater has stopped flowing into the cistern 50, and detector 30 has detected data indicating that the condition of the Combined Sewer System is such that the cistern 50 may be drained without causing a discharge through the CSO. Controller 70 has caused transmitter 40 to stop transmitting the signal to close valve 56. When a signal is no longer being transmitted to the receiver 58, the control valve 56 is open, and the water held in the cistern 50 is discharged through the drainage outlet 54 until the cistern 50 is empty. In this embodiment, a desirable feature of the system is that in the system's default state, the control valve is open to permit flow into the sewer line. However, the system could also be operated so that transmitter 40 issues an “open” signal that results in an active movement of control valve 56 to the open position, for example, if the position of control valve 56 is determined by an electric motor. Following that discharge, the system 100 returns to essentially the state depicted in FIG. 1.

The invention also may comprise a method of using a system disclosed herein for controlling discharges of untreated material from a Combined Sewer System that carries rainwater and sewage from a drainage basin and having a Combined Sewer Overflow for discharging untreated material. An exemplary embodiment of a method according the invention includes providing at least one cistern 50 located within the drainage basin served by the Combined Sewer System as seen in FIG. 1. The cistern 50 is positioned to capture rainwater that is collected from a portion of the drainage basin. The cistern 50 has a drainage outlet 54 for discharging water into the Combined Sewer System, the drainage outlet 54 having a control valve 56 positioned to control water flow through the drainage outlet 54. The cistern 50 also has an overflow outlet 60 configured to discharge rainwater in the event that the cistern 50 contains an amount of water approaching its capacity. The exemplary method further comprises providing detector 30, which receives data that correlate to a discharge from the CSO; providing a controller 70 for receiving the data and causing transmitter 40 to make appropriate transmissions; providing a transmitter 40 for remotely controlling the control valve 56; and transmitting a signal to control the control valve 56 so that, when data available from the detector 30 indicates that no discharge from the Combined Sewer Overflow is imminent, the control valve 56 permits water to flow out of the cistern 50 through the drainage outlet 54, and when data available from the detector indicates that discharge from the Combined Sewer Overflow is imminent, the control valve 56 does not permit water to flow out of the cistern 50 through the drainage outlet 54.

While the invention has been described by illustrative embodiments, additional advantages and modifications will occur to those skilled in the art. Therefore, the invention in its broader aspects is not limited to specific details shown and described herein. Modifications, for example, could include changes to the materials used to make the cisterns; the use of different devices or methods to transmit signals among the detector, controller, transmitter, receiver and control valve; and the use of a controller that is a special-purpose computer, or electronic controllers rather than a general-purpose computer. These modifications may be made without departing from the spirit and scope of the invention. Accordingly, it is intended that the invention not be limited to the specific illustrative embodiments, but be interpreted within the full spirit and scope of the appended claims and their equivalents.

I claim:

1. A system for controlling discharges of untreated water from a Combined Sewer System carrying rainwater and sewage from a drainage basin and having a Combined Sewer Overflow for discharging untreated water, comprising:
at least one cistern located within the drainage basin served by the Combined Sewer System, the cistern being positioned to capture rainwater that is collected from a portion of the drainage basin, the cistern having a drainage outlet for discharging water into the Combined Sewer System, the drainage outlet having a control valve positioned to control water flow through the drainage outlet, and the cistern also having an overflow outlet configured to discharge rainwater in the event that the cistern contains an amount of water exceeding its capacity;
a detector for obtaining data that correlates with water being discharged through the Combined Sewer Overflow;
and a transmitter in operative communication with both the detector and the control valve for remotely controlling the control valve based on data obtained by the detector.

2. A system according to claim 1, wherein the portion of the drainage basin from which rainwater is captured is the roof of a building.

3. A system according to claim 1, further comprising a receiver for receiving signals from the transmitter.

4. A system according to claim 1, further comprising a solenoid valve in operative communication with the receiver and the control valve such that the control valve is opened and closed in response to a signal sent from the transmitter to the receiver and causing the receiver to send a control signal to the solenoid.

5. A system according to claim 4 wherein the control valve is configured so that when the control valve is not receiving a signal, the control valve permits rainwater to flow out of the cistern through the control valve.

6. A system according to claim 4, wherein the discharge outlet is located in the lower portion of the cistern, and the overflow outlet being located in the upper portion of the cistern.

7. A system according to claim 1, further comprising a controller in operative communication with the detector and the transmitter, wherein the controller receives data from the detector, processes the data to determine when a signal to close the control valve should be communicated to the control valve, and commands the transmitter to transmit a signal that to close the control valve.

8. A system according to claim 7, wherein the controller is a general-purpose computer.

9. A system according to claim 1, further comprising a plurality of additional cisterns, wherein each cistern has a control valve.

10. A system according to claim 9, wherein at least two of the control valves are controlled separately so a first one of the control valves can be opened and closed independently of a second one of the control valves.

11. A method of controlling discharges of untreated material from a Combined Sewer System that carries rainwater and sewage from a drainage basin and having a Combined Sewer Overflow for discharging untreated material, comprising:
providing at least one cistern located within the drainage basin served by the Combined Sewer System, the cistern being positioned to capture rainwater that is collected from a portion of the drainage basin, the cistern having a drainage outlet for discharging water into the Combined Sewer System, the drainage outlet having a control valve positioned to control water flow through the drainage outlet, and the cistern having an overflow outlet configured to discharge rainwater in the event that the cistern contains an amount of water approaching its capacity;
providing a detector for obtaining data that correlates with water being discharged through the Combined Sewer Overflow;
providing a transmitter for remotely controlling the control valve; and
transmitting a signal to control the control valve so that, when data available from the detector indicates that no discharge from the Combined Sewer Overflow is imminent, the control valve permits water to flow out of the cistern through the drainage outlet, and when data available from the detector indicates that no discharge from the Combined Sewer Overflow is imminent, the control valve does not permit water to flow out of the cistern through the drainage outlet.
